(19) United States
(12) Patent Application Publication
(10) Pub. No.: US 2009/0153116 A1
(43) Pub. Date: Jun. 18, 2009

(54) SWITCHING CONTROLLER AND SEMICONDUCTOR DEVICE USED IN THE SAME

(75) Inventor: Yoshiaki Hachiya, Shiga (JP)

Correspondence Address: STEPTOE & JOHNSON LLP, 1330 CONNECTICUT AVE., NW, WASHINGTON, DC, 20036, US

(73) Assignee: Panasonic Corporation, Kadoma-shi (JP)

(21) Appl. No.: 12/326,928

(22) Filed: Dec. 3, 2008

(30) Foreign Application Priority Data
Dec. 12, 2007 (JP) 2007-320269

(51) Int. Cl. G05F 1/56

(52) U.S. Cl. 323/282

(57) ABSTRACT

According to the present invention, in a switching power supply, a feedback signal from an output voltage detection circuit 6 through a light emitting part 7-1 and a light receiving part 7-2 of a photocoupler 7 is combined with an output voltage signal VA from a tertiary winding 1-3 of a transformer 1, and a composite signal is inputted to an FB terminal of a control circuit 5.

### FIELD OF THE INVENTION

The present invention relates to a switching controller for controlling switching in, for example, a switching power supply, and a semiconductor device used in the same.

### BACKGROUND OF THE INVENTION

A switching controller of the prior art will be described below in accordance with the accompanying drawings.

FIG. 24 is a circuit diagram showing the configuration of the switching controller according to the prior art (for example, see Japanese Patent Laid-Open No. 2003-189619). FIG. 25 is a waveform chart showing operations in the switching controller of FIG. 24.

In FIG. 24, reference numerals 101 and 102 denote AC power supply input terminals, reference numeral 103 denotes a rectifying/smoothing circuit, reference numerals 104 and 105 denote DC power supply input terminals, reference numeral 106 denotes a switching element, reference numeral 107 denotes a capacitor, reference numeral 108 denotes a starting resistor, reference numeral 109 denotes a primary winding, reference numeral 110 denotes a secondary winding, reference numeral 111 denotes a transformer, reference numeral 112 denotes a rectifying/smoothing circuit, reference numeral 113 denotes a diode, reference numeral 114 denotes a capacitor, reference numerals 115 and 116 denote output terminals, reference numeral 117 denotes a load, reference numeral 118 denotes an output DC voltage detection circuit, reference numeral 119 denotes an auxiliary winding, reference numeral 120 denotes a ringing generating circuit, reference numeral 121 denotes a diode, reference numeral 122 denotes a resistor, reference numeral 123 denotes a capacitor, reference numeral 124 denotes a resistor, reference numeral 125 denotes an output smoothing circuit, reference numeral 126 denotes a capacitor, reference numeral 127 denotes a diode, reference numeral 128 denotes a control circuit, reference numeral 129 denotes a comparator, reference numeral 130 denotes a reference voltage, reference numeral 131 denotes a comparator circuit, reference numeral 132 denotes an ON period control circuit, reference numeral 133 denotes a bottom counter circuit, reference numeral 134 denotes a delay circuit, reference numeral 135 denotes a pulse control circuit, reference numeral 136 denotes a drive circuit, reference numeral 137 denotes an OR circuit, and reference numerals 138, 139 and 140 denote inverters.

In the switching controller including these constituent elements, as shown in FIGS. 24 and 25, a low V1 voltage of the switching element 106 is detected and the switching element is turned on. Further, as a voltage between the output terminals 115 and 116, the output voltage of the rectifying/smoothing circuit 112 is fed back to the control circuit 128 through the output DC voltage detection circuit 118.

In the switching controller configured thus, a low V1 voltage of the switching element 106 is detected and the switching element is turned on, thereby reducing a power loss and noise generation that are caused by switching.

However, the switching controller including the output DC voltage detection circuit 118 according to the prior art has the following problems:

(1) Generally when the functionality of a control circuit is improved in response to improved characteristics such as energy conservation and noise reduction in a switching power supply, a function terminal for inputting a signal from the outside has to be added for each function to the control circuit made up of a semiconductor device, so that the number of function terminals of the control circuit increases with functionality. Thus from the viewpoint of a manufacturer, the area of a semiconductor chip increases with the number of function terminals acting as the external terminals of the control circuit, so that a large semiconductor package with multiple pins is required and interferes with size and cost reduction of the power supply.

For example, in the control circuit 128 of the switching controller of the prior art in FIG. 24, the switching of the switching element 106 can be controlled only by an input terminal for inputting a feedback signal from the output DC voltage detection circuit 118. However, in order to improve characteristics such as energy conservation and noise reduction in the switching power supply, in the case where the switching element 106 is turned on when the switching element 106 has a relatively low V1 voltage, it is necessary to provide an input terminal for inputting a signal from the ringing generating circuit 120 in addition to the feedback signal input terminal.

(2) Further, in the switching controller of the prior art, the oscillation frequency of the switching element changes with a load condition of an output. Thus the size of the transformer 111 increases and interferes with further size reduction of the switching controller, so that only a large set, that is, only a set substantially designed for a high-power switching controller can be used and the configuration is limited.

According to (1) and (2), it is difficult to simultaneously reduce the size of the switching controller and noise in the switching controller of the prior art.

### DISCLOSURE OF THE INVENTION

The present invention has been devised to solve the problems of the prior art. An object of the present invention is to provide a switching controller and a semiconductor device used in the same which can achieve high performance and high functionality with further noise reduction and so on and can simultaneously suppress an increase in the number of function terminals even when the number of functions increases with functionality, thereby reducing the size of the overall device.

In order to solve the problems, a switching controller of the present invention includes: a switching element for turning on/off a DC voltage; a composite signal generating circuit for generating a composite signal from a plurality of different input signals; and a control circuit for controlling the on/off operation of the switching element in response to the composite signal from the composite signal generating circuit.

With this configuration, the number of input signals can be reduced by combining signals inputted to the control circuit, thereby reducing the number of external terminals of the control circuit to which the signals are inputted. It is thus possible to improve the characteristics of the switching controller without increasing the size and price of the switching controller.

A switching controller of the present invention includes: an input terminal fed with a DC voltage; a transformer including a primary winding having one end connected to the input terminal and the other end connected to the high-potential side terminal of a switching element, a secondary winding connected to an output voltage detection circuit via a rectifying/smoothing circuit, and a tertiary winding connected to a composite signal generating circuit connected to the output terminal of the output voltage detection circuit to generate a composite signal; and a control circuit for controlling the on/off operation of the switching element on the DC voltage in response to the composite signal from the composite signal generating circuit.

With this configuration, the number of input signals can be reduced by combining signals inputted to the control circuit, thereby reducing the number of external terminals of the control circuit to which the signals are inputted. It is thus possible to improve the characteristics of the switching controller without increasing the size and price of the switching controller.

Further, the composite signal generating circuit generates the composite signal from a plurality of different input signals by using the on period and the off period of the switching element such that the signals do not interfere with each other, and the control circuit processes the composite signal from the composite signal generating circuit in the on period and the off period of the switching element, and controls the on/off operation of the switching element based on a processing signal.

Thus the control circuit can achieve a stable on/off operation of the switching element.

Moreover, the composite signal generating circuit includes at least a diode.

Further, the composite signal generating circuit includes at least a diode and a Schottky diode.

Moreover, the composite signal generating circuit includes at least a diode, a Schottky diode, and a photocoupler.

Further, the control circuit controls the on/off operation of the switching element based on the composite signal from the composite signal generating circuit such that a current passing through the switching element is adjusted in response to an output signal from the output voltage detection circuit in the on period of the switching element and the timing of the turn-on of the switching element is adjusted in response to an output signal from the tertiary winding of the transformer in the off period of the switching element.

It is thus possible to gradually shift the timing of the turn-on of the switching element each time, thereby reducing the level of noise generated by the switching operation of the switching element.

Moreover, the control circuit controls the on/off operation of the switching element based on the composite signal from the composite signal generating circuit such that a current passing through the switching element is adjusted in response to an output signal from the output voltage detection circuit in the on period of the switching element and the timing of the turn-on of the switching element is adjusted in response to a reference signal from an oscillator for generating the timing of switching and an output signal from the tertiary winding of the transformer in the off period of the switching element.

It is thus possible to gradually shift the timing of the turn-on of the switching element each time, thereby further reducing the level of noise generated by the switching operation of the switching element.

Further, the control circuit includes an overcurrent detection circuit for detecting a current passing through the switching element and setting the maximum value of the detected current; and an overload detection circuit for detecting an overloaded condition of the output terminal according to the number of times that the current passing through the switching element reaches the maximum value of the detected current of the overcurrent detection circuit.

It is thus possible to add an overload detecting function without increasing the number of function terminals of the control circuit, thereby increasing the safety of the switching controller.

Moreover, the control circuit includes an adjusting circuit for detecting one of an unloaded condition and a light-load condition based on the composite signal from the composite signal generating circuit in the on period of the switching element and adjusting an oscillation condition of the switching element.

It is thus possible to save energy in the standby state of the switching controller.

Further, the adjusting circuit changes the oscillation frequency of the switching element.

It is thus possible to save energy in the standby state of the switching controller.

The adjusting circuit stops or suspends the on/off control of the switching element.

It is thus possible to save energy in the standby state of the switching controller.

Moreover, the oscillator uses, as the reference signal, a triangular wave changing according to the composite signal from the composite signal generating circuit in the on period of the switching element.

It is thus possible to gradually shift the timing of the turn-on of the switching element, thereby reducing the level of noise generated by the switching operation of the switching element.

In the switching controller, a semiconductor device of the present invention is configured such that the switching element and the control circuit are formed as an integrated circuit on the same semiconductor substrate or mounted in the same package and at least four terminals are provided.

It is thus possible to achieve a stable operation of the switching controller and reduce the size and price of the switching controller.

As has been discussed, according to the present invention, the composite signal having different signals not interfering with each other in the on state and the off state of the switching element can be inputted to the single function terminal as a control signal for controlling switching.

It is thus possible to achieve high performance and high functionality with further noise reduction and so on and simultaneously suppress an increase in the number of function terminals even when the number of functions increases with functionality, thereby reducing the size of the overall device.

### BRIEF DESCRIPTION OF THE DRAWINGS

FIG. 1 is a circuit diagram showing the configuration of a switching controller according to a first embodiment of the present invention;

FIG. 2 is a voltage waveform chart of each part of the switching controller according to the first embodiment;

FIG. 3 is a voltage waveform chart of each part when a switching element having a proper built-in diode tolerance is used in the switching controller of the first embodiment;

FIG. 4 is a block diagram showing a first structural example of a semiconductor device used in the switching controller of the first embodiment;

FIG. 5 is a voltage waveform chart of each part when the first structural example of the semiconductor device is used in the switching controller of the first embodiment;

FIG. 6 is a switching element current waveform chart of an output voltage VOUT when the first structural example of the semiconductor device is used in the switching controller of the first embodiment;

FIG. 7 is a block diagram showing a second structural example of the semiconductor device used in the switching controller of the first embodiment;

FIG. 8 is an operation explanatory drawing of an overload detection circuit in the second structural example of the semiconductor device used in the switching controller of the first embodiment;

FIG. 9 is a block diagram showing a third structural example of the semiconductor device used in the switching controller of the first embodiment;

FIG. 10 is a switching element current waveform chart of the output voltage VOUT when the third structural example of the semiconductor device is used in the switching controller of the first embodiment;

FIG. 11 is a block diagram showing a fourth structural example of the semiconductor device used in the switching controller of the first embodiment;

FIG. 12 is an operation explanatory drawing of a triangular frequency adjusting circuit in the fourth structural example of the semiconductor device used in the switching controller of the first embodiment;

FIG. 13 is a block diagram showing a fifth structural example of the semiconductor device used in the switching controller of the first embodiment;

FIG. 14 is a circuit diagram showing the configuration of a switching controller according to a second embodiment of the present invention;

FIG. 15 is a circuit diagram showing the configuration of a switching controller according to a third embodiment of the present invention;

FIG. 16 is a block diagram showing a sixth structural example of a semiconductor device used in the switching controller of the third embodiment;

FIG. 17 is a block diagram showing a seventh structural example of the semiconductor device used in the switching controller of the third embodiment;

FIG. 18 is a circuit diagram showing the configuration of a switching controller according to a fourth embodiment of the present invention;

FIG. 19 is a voltage waveform chart of each part of the switching controller according to the fourth embodiment;

FIG. 20 is a voltage waveform chart of each part when a switching element having a proper built-in diode tolerance is used in the switching controller of the fourth embodiment;

FIG. 21 is a voltage waveform chart of each part when first to fifth structural examples of the semiconductor device are used in the switching controller of the fourth embodiment;

FIG. 22 is a circuit diagram showing the configuration of a switching controller according to a fifth embodiment of the present invention;

FIG. 23 is a circuit diagram showing the configuration of a switching controller according to a sixth embodiment of the present invention;

FIG. 24 is a circuit diagram showing the configuration of a switching controller of the prior art; and

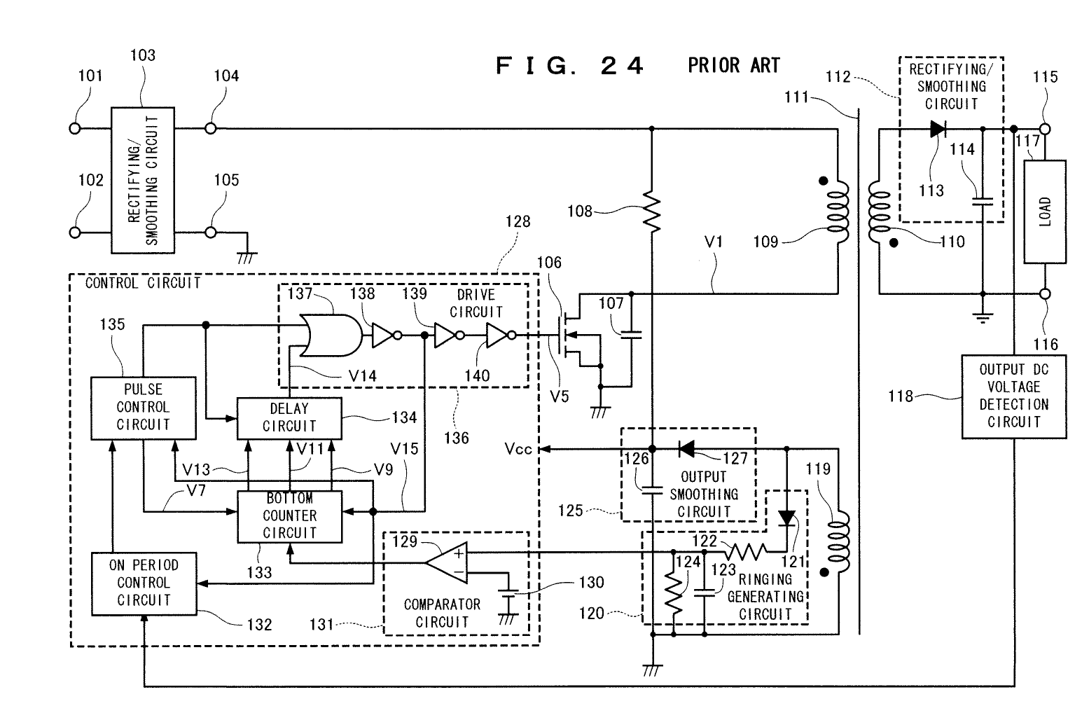

FIG. 25 is a waveform chart showing operations in the switching controller of the prior art example.

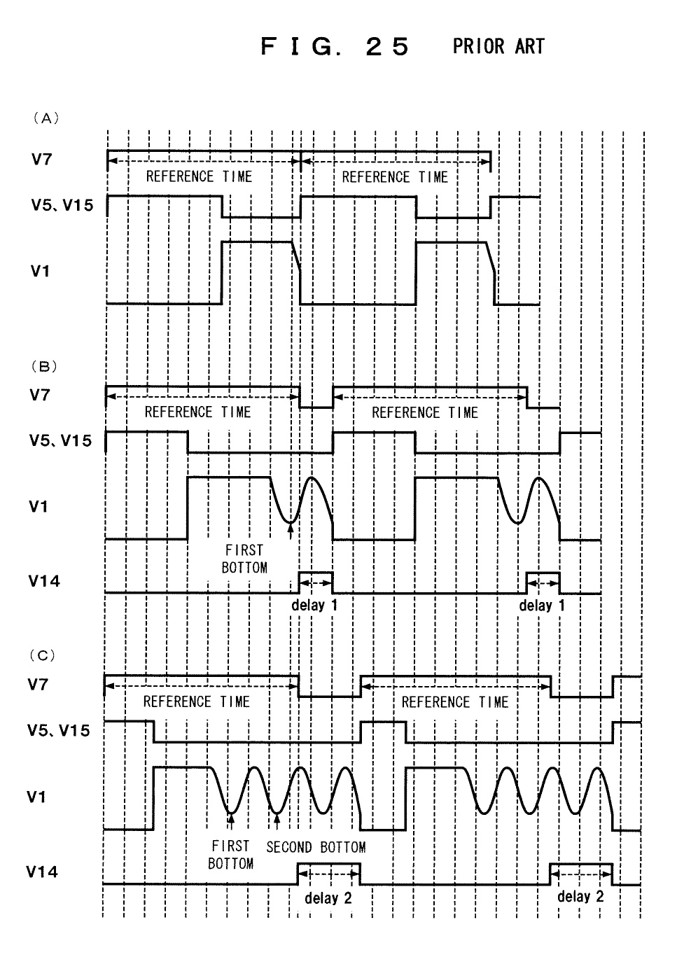

### DESCRIPTION OF THE EMBODIMENTS

A switching controller representing embodiments of the present invention and a semiconductor device used in the same will be specifically described below in accordance with the accompanying drawings.

### First Embodiment

The following will describe a switching controller and a semiconductor device used in the same according to a first embodiment of the present invention.

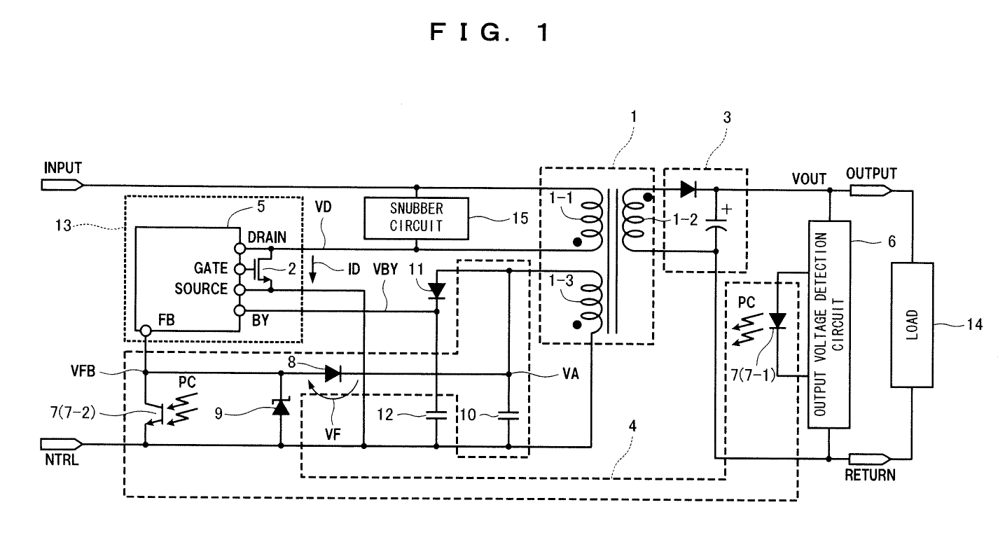

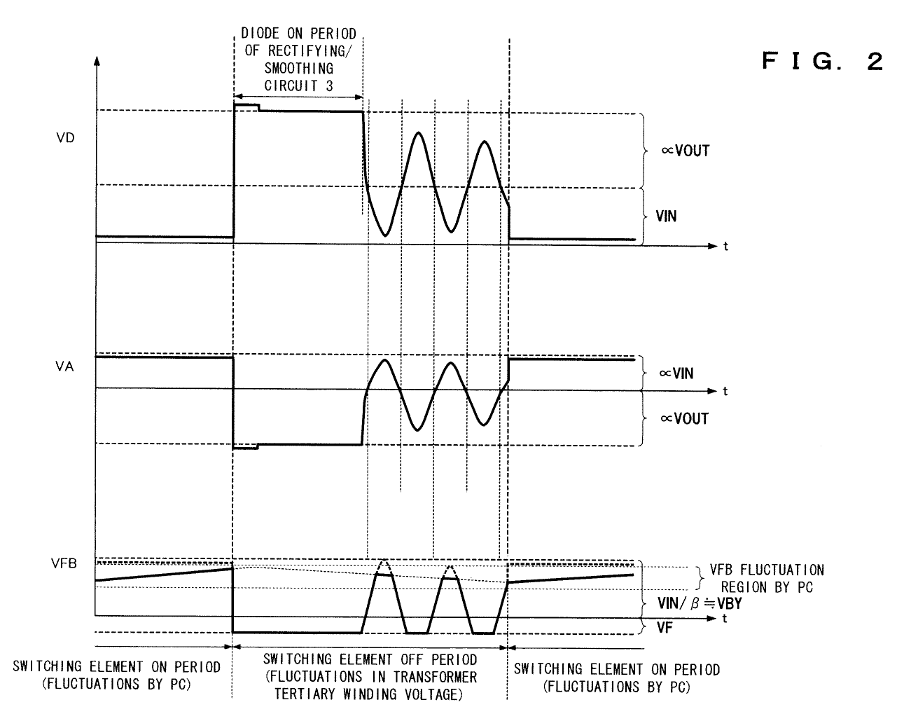

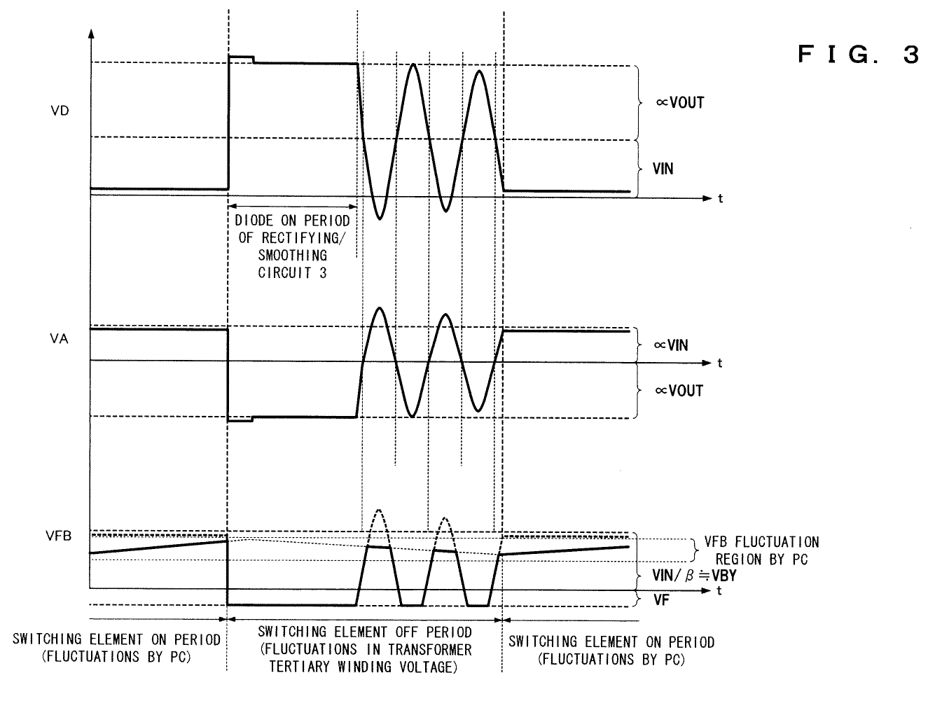

FIG. 1 shows the switching controller of the first embodiment. FIG. 2 shows waveforms at each point of the switching controller according to the first embodiment. FIG. 3 shows waveforms at each point of the switching controller according to the first embodiment when a switching element 2 has a proper built-in diode tolerance.

Between INPUT and NTRL in FIG. 1, a voltage obtained by rectifying and smoothing an AC power is inputted or a DC voltage is inputted. Between INPUT and NTRL, a primary winding 1-1 of a transformer 1 and the switching element 2 are connected. A rectifying/smoothing circuit 3 is connected to a secondary winding 1-2 of the transformer 1, and a composite signal generating circuit 4 is connected to a tertiary winding 1-3 of the transformer 1.

The on/off of the switching element 2 is controlled by a control circuit 5. By inputting the output signal of the composite signal generating circuit 4 from an FB terminal, stable control is performed in the switching controller.

In the composite signal generating circuit 4, an output signal from an output voltage detection circuit 6 is transmitted to the FE terminal of the control circuit 5 through a photocoupler 7 (light emitting part: 7-1, light receiving part: 7-2). Further, in a period during which the winding voltage (forward connection) of the tertiary winding 1-3 of the transformer 1 is lower than an FB terminal voltage (in other words, the off period of the switching element 2), waveforms proportionate to fluctuations in the voltage of the tertiary winding 1-3 of the transformer are formed as shown in FIGS. 2 and 3 because a diode 8 is connected between the FB terminal of the control circuit 5 and the tertiary winding 1-3 of the transformer 1.

As shown in FIG. 1, a Schottky diode 9 is connected to the FB terminal, so that the FB terminal voltage is clamped so as not to shift in a negative direction (for example, not higher than −0.5 V). Further, a capacitor 10 adjusts the timing of the turn-on of the switching element 2. When a switching loss is to be reduced, a constant is set so as to turn on the switching element 2 at a DRAIN terminal voltage VD as close as possible to the bottom voltage.

When the switching element 2 has a proper built-in diode tolerance, as shown in FIG. 3, the DRAIN terminal voltage VD of the switching element 2 can be a negative voltage. Thus the capacitor 10 does not have to adjust the timing of the turn-on of the switching element 2, eliminating the need for the capacitor 10. To the tertiary winding 1-3 of the transformer 1, a diode 11 and a capacitor 12 are connected and a voltage across the capacitor 12 is set as a BY terminal voltage (power supply voltage) of the control circuit 5.

Reference numeral 13 denotes the semiconductor device in which the switching element 2 and the control circuit 5 are each made up of at least a single chip (for example, the switching element 2 and the control circuit 5 are made up of different semiconductor chips or mounted on the same semiconductor substrate, also in the semiconductor devices of all the other embodiments that will be described later). A load 14 is connected to an output terminal OUTPUT and a snubber circuit 15 is connected to the primary winding of the transformer 1.

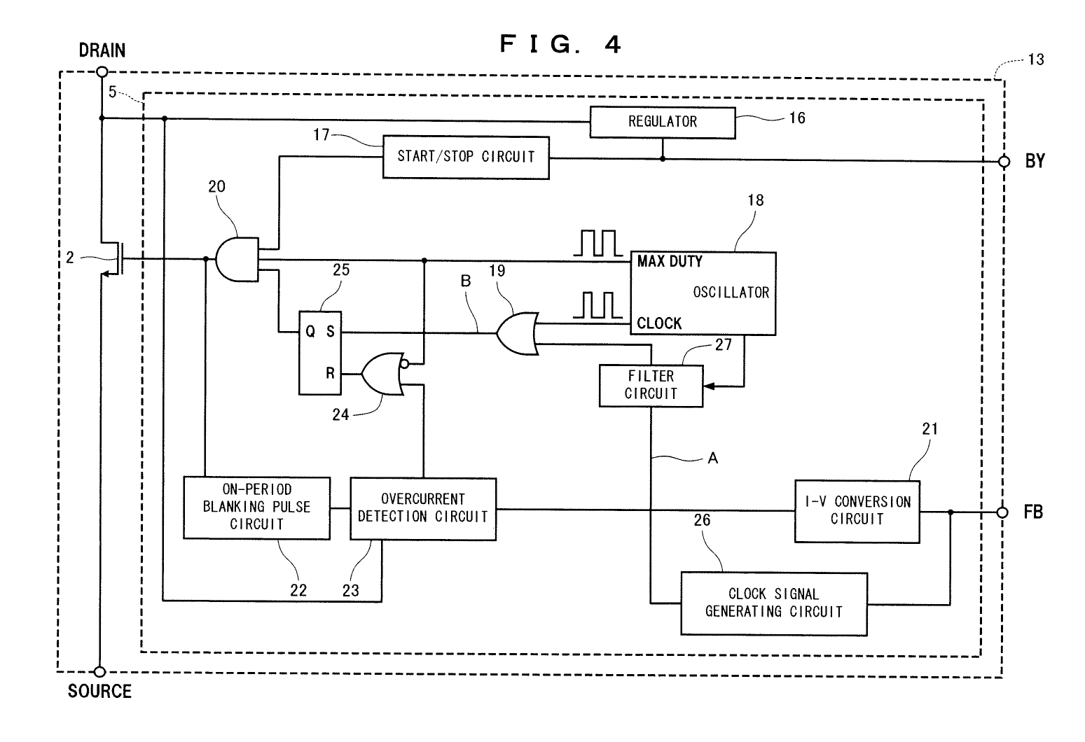

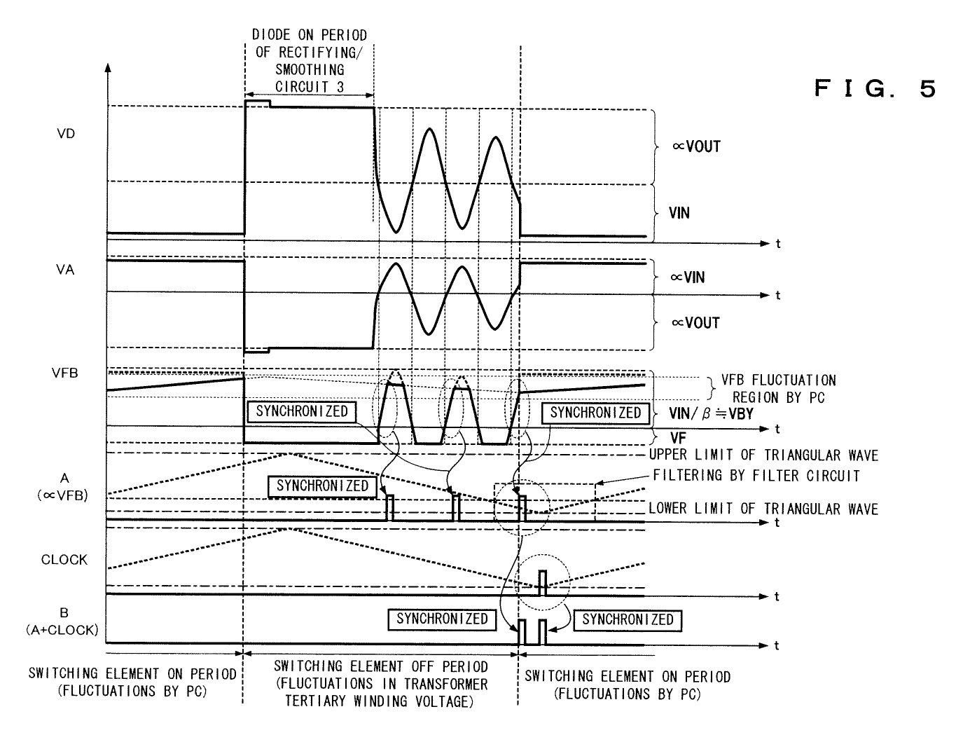

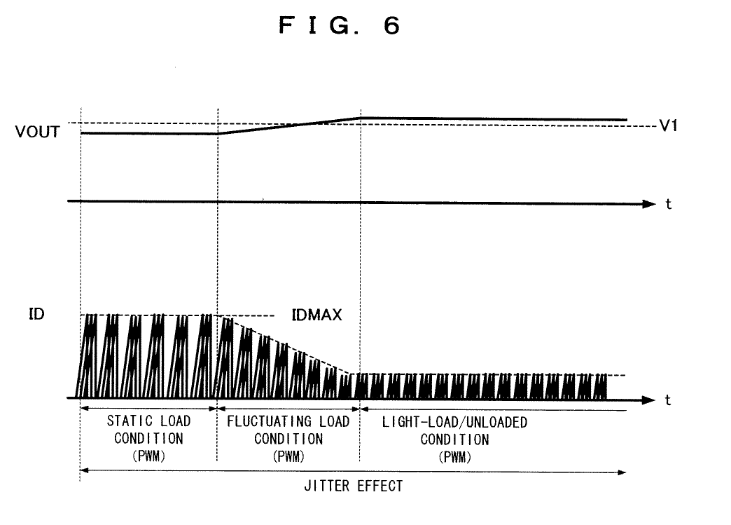

Referring to FIGS. 5 and 6, the following will describe the case where a first structural example of a semiconductor device shown in FIG. 4 according to the embodiment is used as a semiconductor device 13 of FIG. 1. FIG. 5 shows voltage waveforms at each point of FIG. 2 and voltage waveforms at each point in the control circuit 5 of FIG. 4. FIG. 6 shows a DRAIN terminal current waveform ID and a switching control state relative to changes in the load condition of the output load 14 when using the first structural example of the semiconductor device shown in FIG. 4 according to the embodiment. IDMAX represents the maximum value of the overcurrent detection level of an overcurrent detection circuit 23 (that is, the maximum value of current passing through the switching element 2).

A voltage signal VFB inputted to the FB terminal of the control circuit 5 is affected only by feedback signals from the photocoupler 7 in the on period of the switching element 2, and thus the switching of the switching element 2 is ordinarily controlled by the control circuit 5 in response to the output signal of the output voltage detection circuit 6. In the off period of the switching element 2, a signal A (see the waveform in FIG. 5) inputted from a clock signal generating circuit 26 is outputted (in this case, when the signal A is adjusted such that the DRAIN terminal voltage VD is as close as possible to the bottom voltage, switching can be performed with a reduced switching loss).

In this case, the duration of the diode on period of the rectifying/smoothing circuit 3 gradually changes in each off period every time the switching operation of the switching element 2 is performed. Thus the timing of generation of the signal A in response to a triangular wave signal changes every time the switching operation of the switching element 2 is performed. The signal A is filtered by a filter circuit 27 operating in synchronization with the triangular wave of an oscillator 18 and is combined with a CLOCK signal of the oscillator 18 into a signal B.

The switching element 2 is turned on by the signal B. When the signal A is generated (for example, in discontinuous mode), the switching element 2 is turned on depending upon the signal A. When the signal A is not generated (for example, in continuous mode), the switching element 2 is turned on depending upon the CLOCK signal.

Thus as shown in FIG. 6, the oscillation frequency of the switching element 2 has, in the oscillation frequency of the CLOCK signal of the oscillator 18, fluctuations in the oscillation frequency of the signal A having been filtered by the filter circuit 27, thereby achieving a jitter effect without using a jitter generating circuit in the control circuit 5.

Further, the signal A is set so as to reduce the DRAIN terminal voltage VD of the switching element 2 to the bottom voltage, so that bottom-on control can be performed and a switching loss can be reduced at the same time.

As has been discussed, a relationship shown in FIG. 6 is established between an output voltage VOUT and the drain current ID of the switching controller according to the first embodiment. When the first structural example of the semiconductor device of the embodiment is used in the switching controller of the first embodiment, the following effect can be obtained:

By using the composite signal generating circuit 4, it is possible to simultaneously achieve ordinary switching control in response to a feedback signal, a jitter effect, and bottom-on control for reducing a switching loss with the single function terminal (in this case, the FB terminal). Thus it is not necessary to increase the number of function terminals of the control circuit 5, thereby suppressing an increase in the size of the control circuit and difficulty in size reduction of the switching controller.

Further, the oscillation frequency of the switching element 2 has a constant width regardless of the load condition of an output. It is thus possible to reduce the size of the transformer and further reduce size of the switching controller. The semiconductor device is particularly effective for a high-power switching controller.

Moreover, the semiconductor device can be also used for a low-power switching controller and thus is not limited by an output.

When the semiconductor device is used for a low-power switching controller, it is possible to more easily reduce noise, thereby facilitating the design of the switching controller. By configuring the semiconductor device 13 in a single semiconductor package (regardless of the number of semiconductor chips in the package), the size of the switching controller can be reduced.

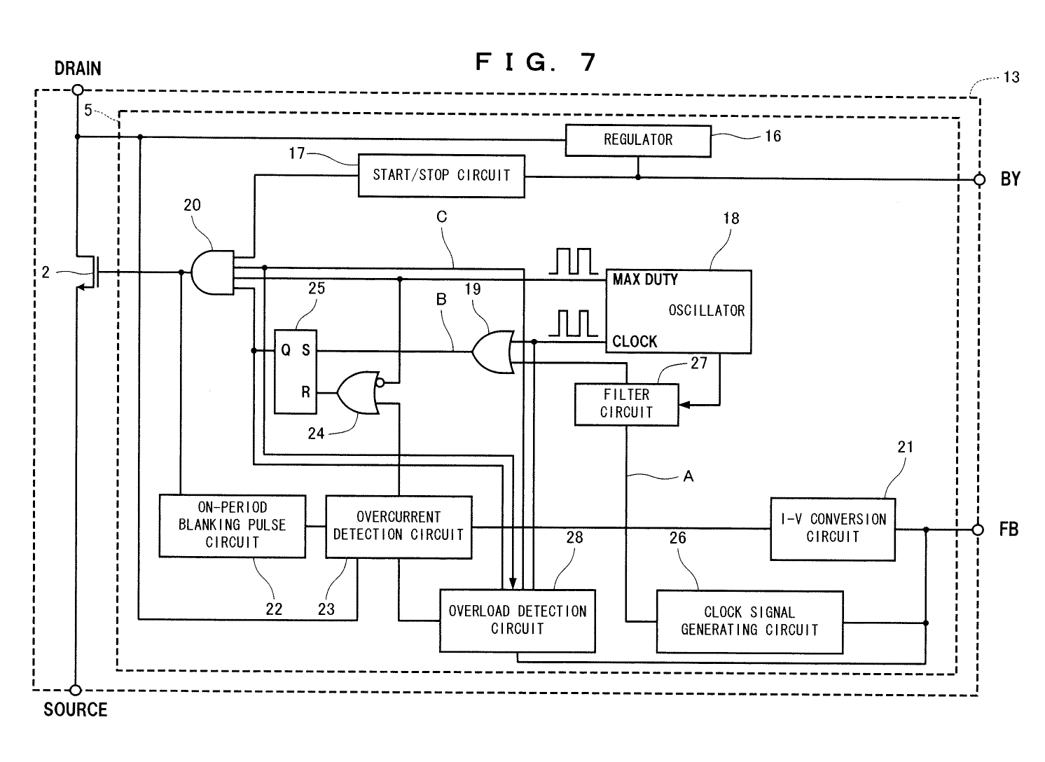

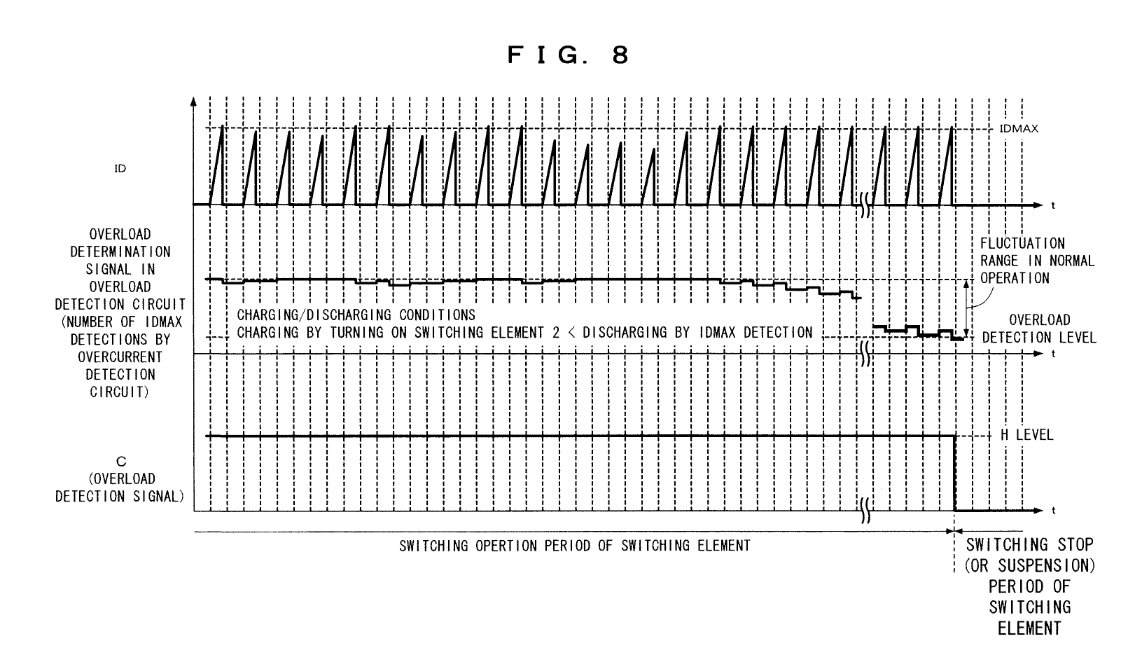

As illustrated in a second structural example of the semiconductor device in FIG. 7 according to the embodiment, the control circuit 5 includes an overload detection circuit 28. FIG. 8 is an operation explanatory drawing of the overload detection circuit 28 when the second structural example of the semiconductor device according to the embodiment is used in the switching controller of the first embodiment. FIG. 8 just shows an example of an operation performed in the overload detection circuit 28.

As shown in FIG. 8, while the load 14 is in an overload condition, the overload detection circuit 28 detects the overload condition when an overcurrent detection circuit 23 detects, a prescribed number of times, that a current passing through the switching element 2 in the on period of the switching element 2 reaches a detection level maximum value IDMAX, so that the switching operation of the switching element 2 is stopped or suspended.

Thus the following effect can be further obtained:

An overload detection function can be further obtained without adding a function pin.

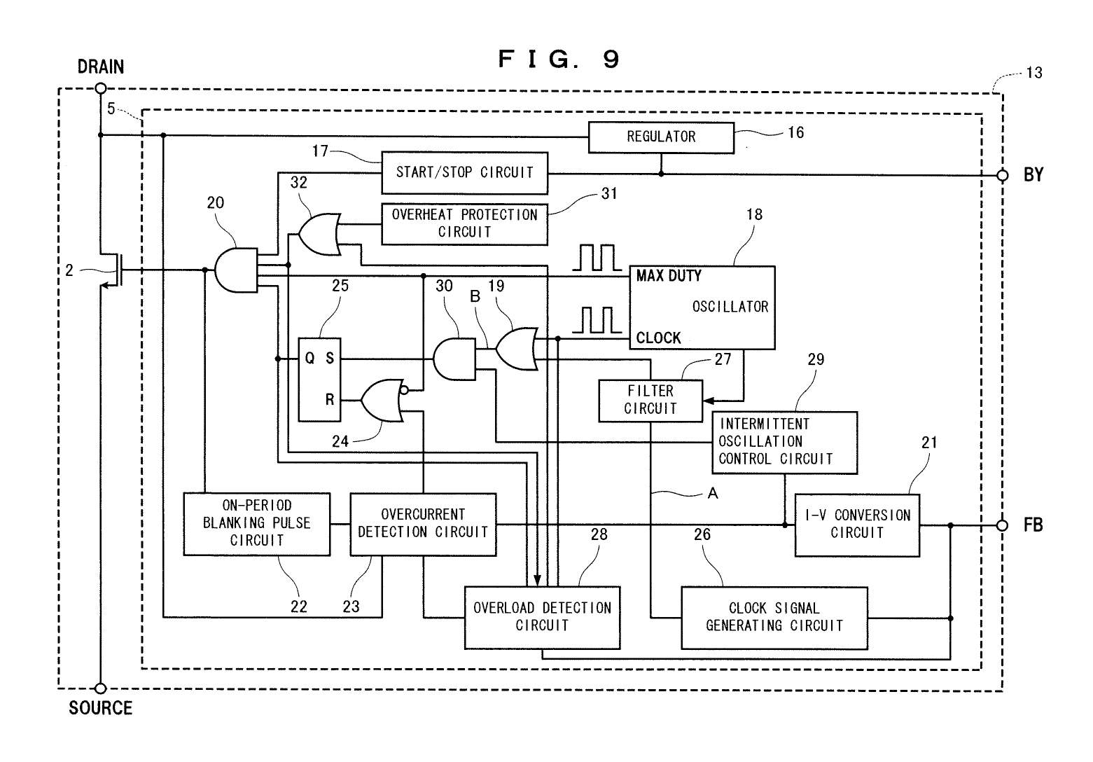

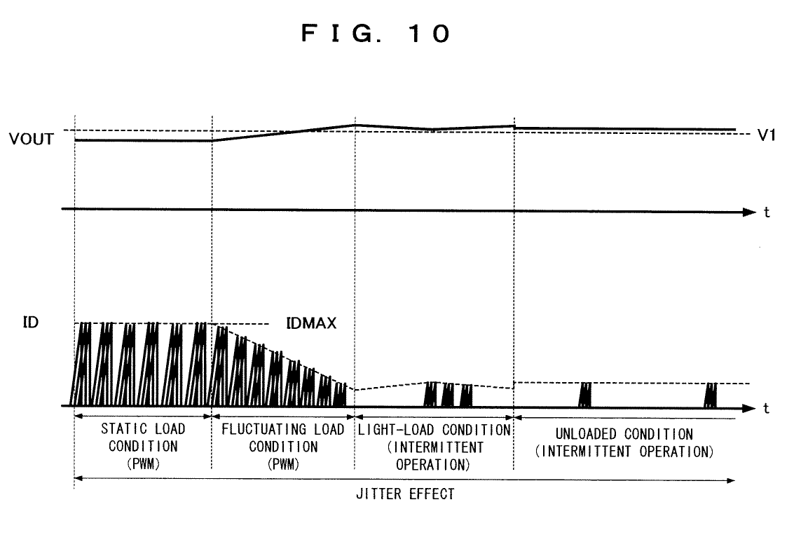

As illustrated in a third structural example of the semiconductor device in FIG. 9 according to the embodiment, the control circuit 5 includes an intermittent oscillation control circuit 29. FIG. 10 shows a DRAIN terminal current waveform ID and a switching control state relative to changes in the load conditions of an output load 14 when using the third structural example of the semiconductor device in FIG. 9 according to the embodiment.

When an unloaded (or light-load) condition of the load 14 is detected according to an FB terminal voltage VFB, the intermittent oscillation control circuit 29 performs intermittent oscillation for stopping or suspending the switching of a switching element 2. Thus the following effect can be further obtained:

It is further possible to reduce a switching loss in an unloaded or a light-load condition, thereby saving more energy.

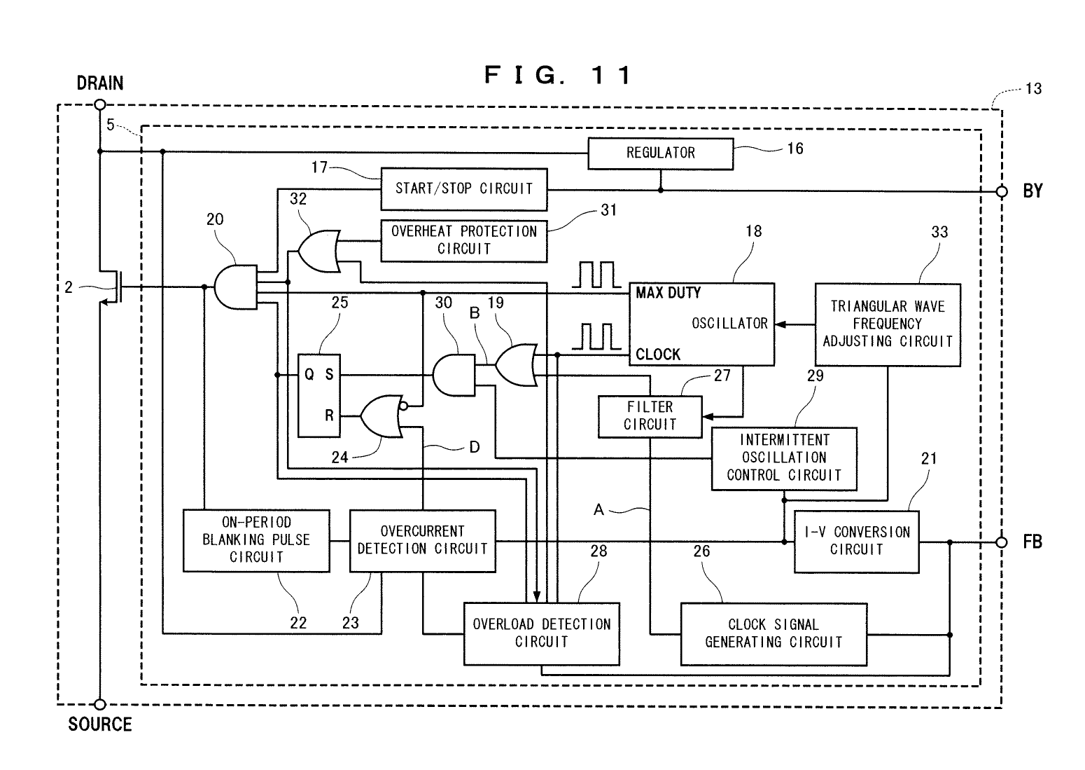

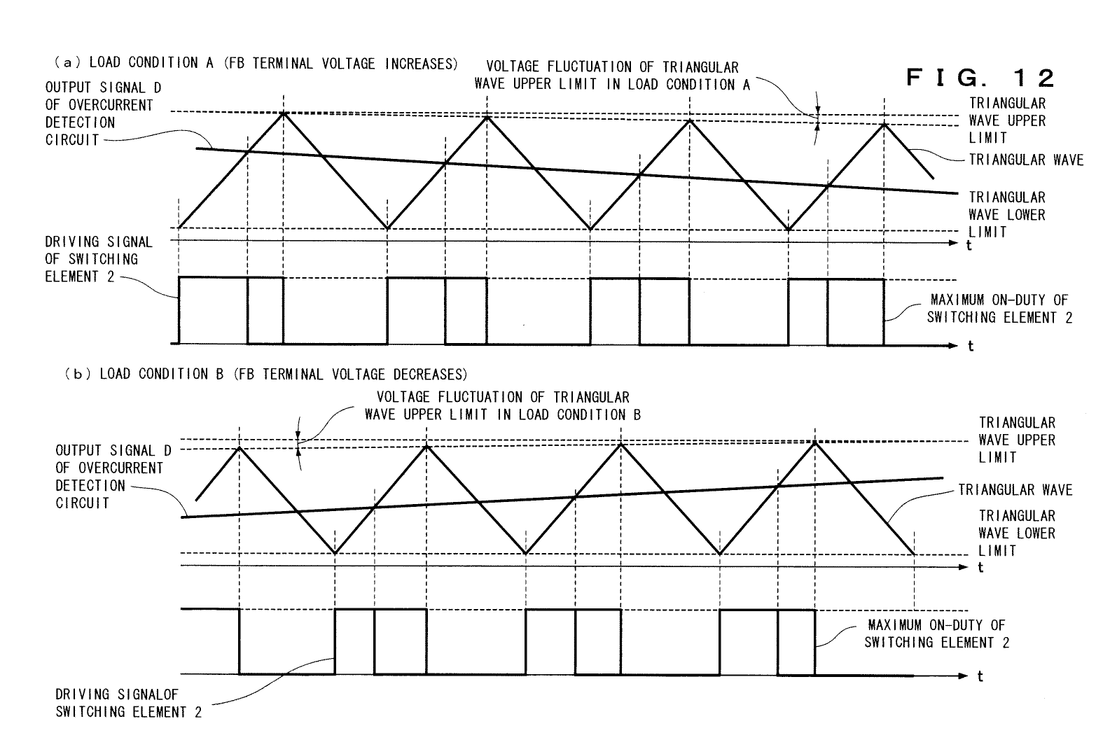

Moreover, as illustrated in a fourth structural example of the semiconductor device in FIG. 11 according to the embodiment, the control circuit 5 includes a triangular wave frequency adjusting circuit 33. FIG. 12 is an operation explanatory drawing of the triangular wave frequency adjusting circuit 33 when the fourth structural example of the semiconductor device according to the embodiment is used in the switching controller of the first embodiment.

The oscillation frequency of a switching element 2 is specified by a CLOCK signal of an oscillator 18, and the maximum on-duty of the switching element 2 is specified by a MAX DUTY signal of the oscillator 18. The two signals (CLOCK signal, MAX DUTY signal) of the oscillator 18 are specified by a triangular wave in the oscillator 18.

The triangular wave frequency adjusting circuit 33 changes the frequency of the triangular wave in the oscillator 18 according to an FB terminal voltage VFB, so that the oscillation frequency of the switching element 2 fluctuates. Thus a jitter effect can be obtained without using a jitter generating circuit in the control circuit 5. Thus the following effect can be further obtained:

In the first structural example of the semiconductor device in FIG. 4 according to the embodiment, the jitter effect is obtained only in discontinuous mode. The addition of the triangular wave frequency adjusting circuit 33 makes it possible to obtain a jitter effect both in discontinuous mode and continuous mode. Thus noise can be further reduced by the jitter effect.

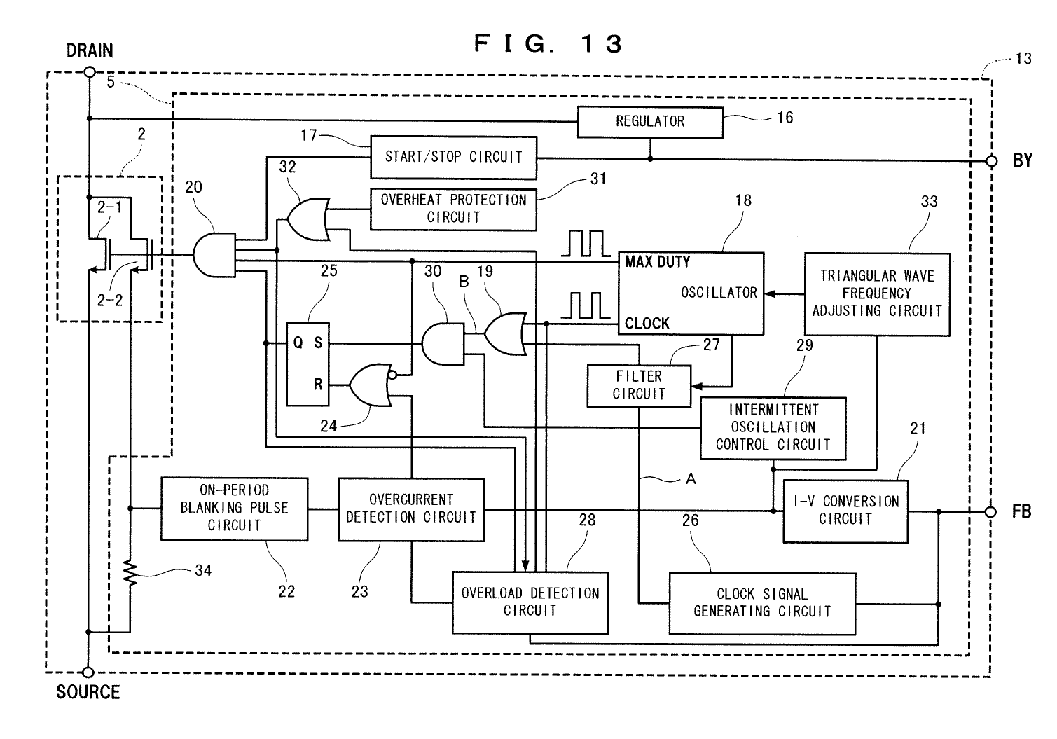

In the first to fourth structural examples of the semiconductor device according to the embodiment, a current passing through the switching element 2 is detected by the overcurrent detection circuit 23 according to the on voltage of the switching element 2. In a fifth structural example of the semiconductor device in FIG. 13 according to the embodiment, the switching element 2 is divided into a high-current passing part 2-1 and a low-current passing part 2-2 and a resistor 34 is connected to the low-current passing part 2-2, so that a current passing through the switching element 2 is detected by a sense method. Thus the same effect can be obtained as the fourth structural example of the semiconductor device according to the embodiment.

### Second Embodiment

The following will describe a switching controller and a semiconductor device used in the same according to a second embodiment of the present invention.

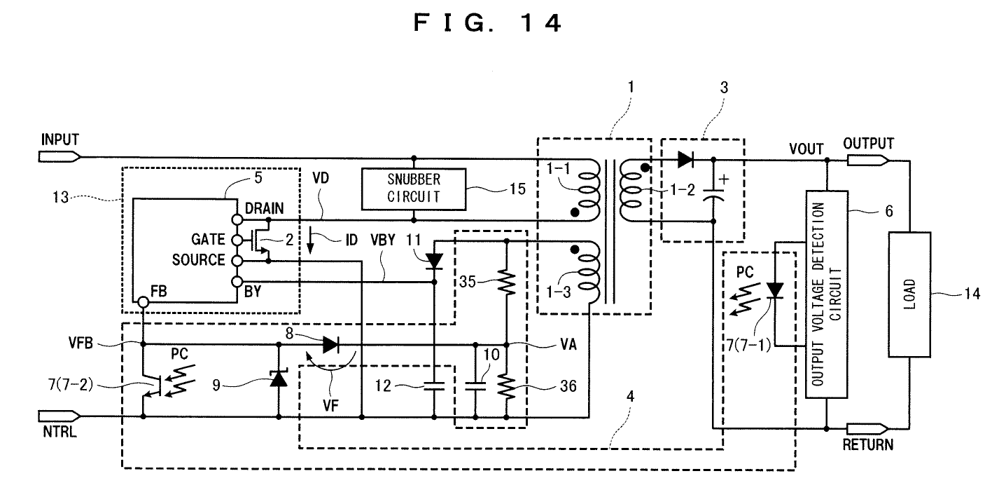

FIG. 14 shows the switching controller of the second embodiment. The second embodiment is different in that two resistors 35 and 36 are added in the composite signal generating circuit 4 of the switching controller of the first embodiment shown in FIG. 1. The same effect can be obtained by the second embodiment and thus only the effect of the addition of the two resistors will be described below.

By adding the two resistors 35 and 36, the amplitude of a ringing voltage waveform generated on a tertiary winding 1-3 of a transformer 1 can be adjusted using the ratio of resistance values in the off period of a switching element 2, so that the following effect can be obtained:

It is possible to adjust the amplitude of an FB terminal voltage VFB waveform generated by the composite signal generating circuit 4 in the off period of the switching element 2.

### Third Embodiment

The following will describe a switching controller and a semiconductor device used in the same according to a third embodiment of the present invention.

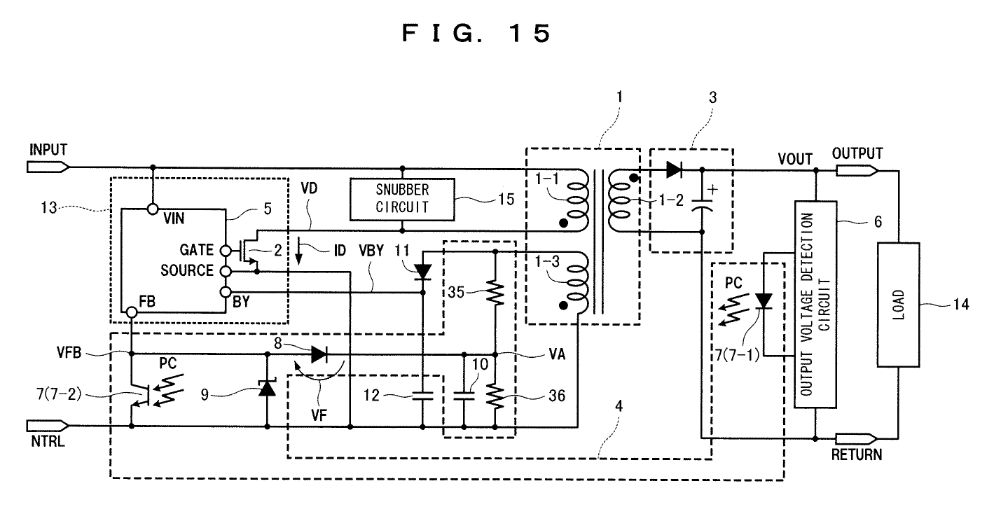

FIG. 15 shows the switching controller of the third embodiment. The third embodiment is different in that power is supplied to a control circuit 5 not from a DRAIN terminal of a switching element 2 but from a VIN terminal connected to an input terminal INPUT. The same effect can be obtained and thus the explanation thereof is omitted.

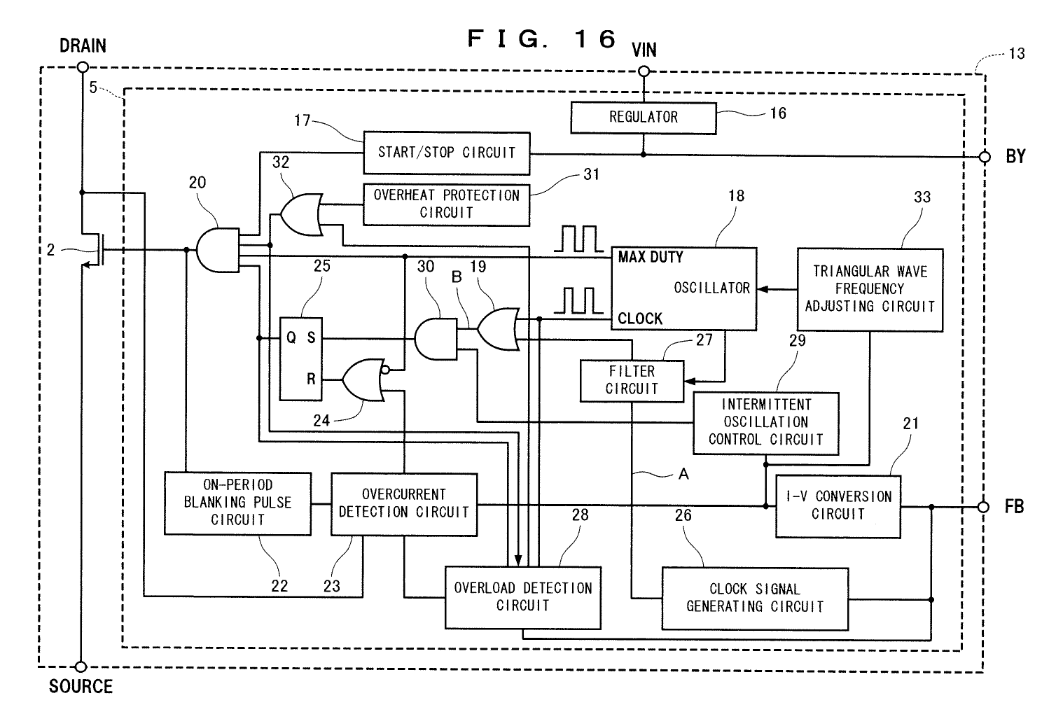

FIG. 16 shows a sixth structural example of the semiconductor device according to an embodiment used in the switching controller of the third embodiment shown in FIG. 15. Unlike the fourth structural example of the semiconductor device of the first embodiment shown in FIG. 11, a regulator 16 is not connected to the DRAIN terminal of the switching element 2 but to the VIN terminal of the control circuit 5. The same operation and effect can be obtained and thus the explanation thereof is omitted.

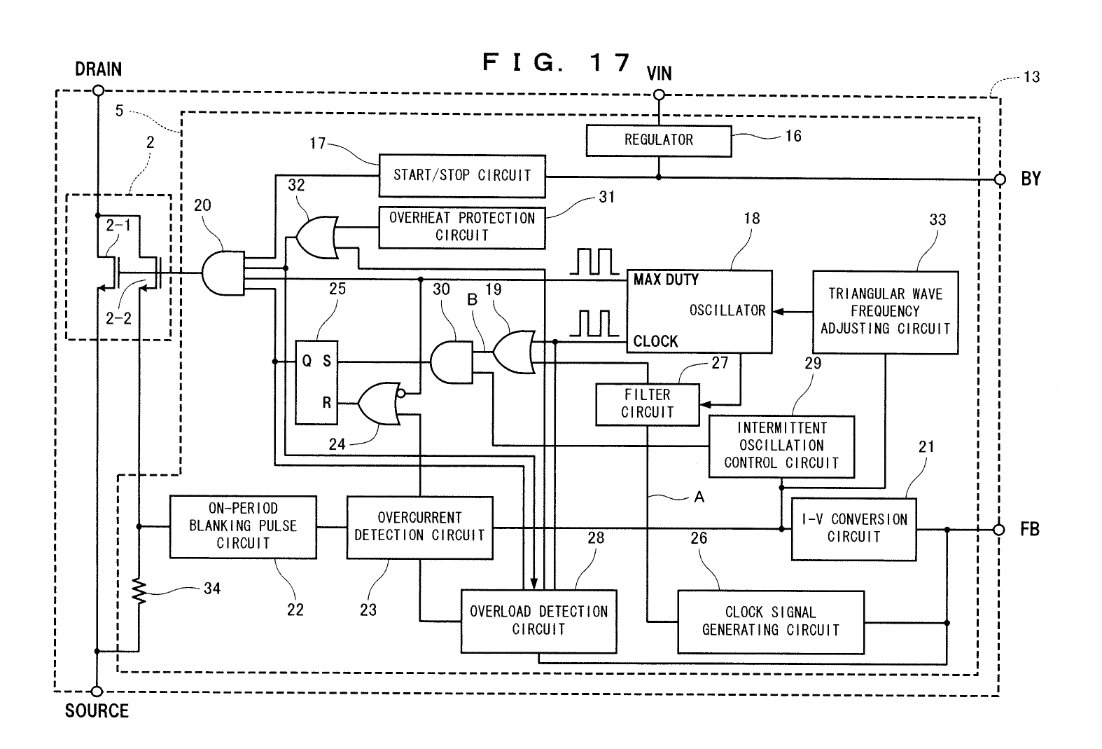

FIG. 17 shows a seventh structural example of the semiconductor device according to an embodiment used in the switching controller of the third embodiment shown in FIG. 15. Unlike the fifth structural example of the semiconductor device of the embodiment shown in FIG. 13, a regulator 16 is not connected to the DRAIN terminal of the switching element 2 but to the VIN terminal of the control circuit 5. The same operation and effect can be obtained and thus the explanation thereof is omitted.

### Fourth Embodiment

The following will describe a switching controller and a semiconductor device used in the same according to a fourth embodiment of the present invention.

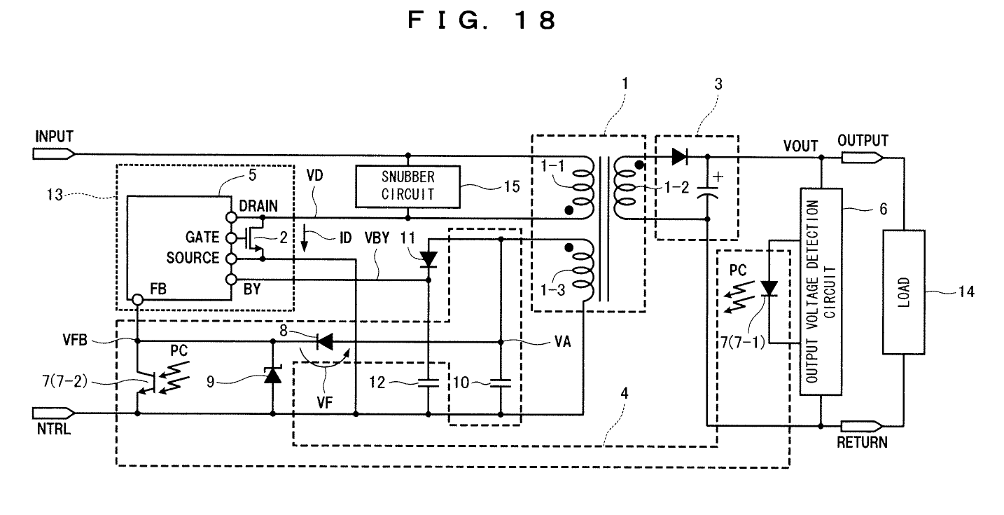

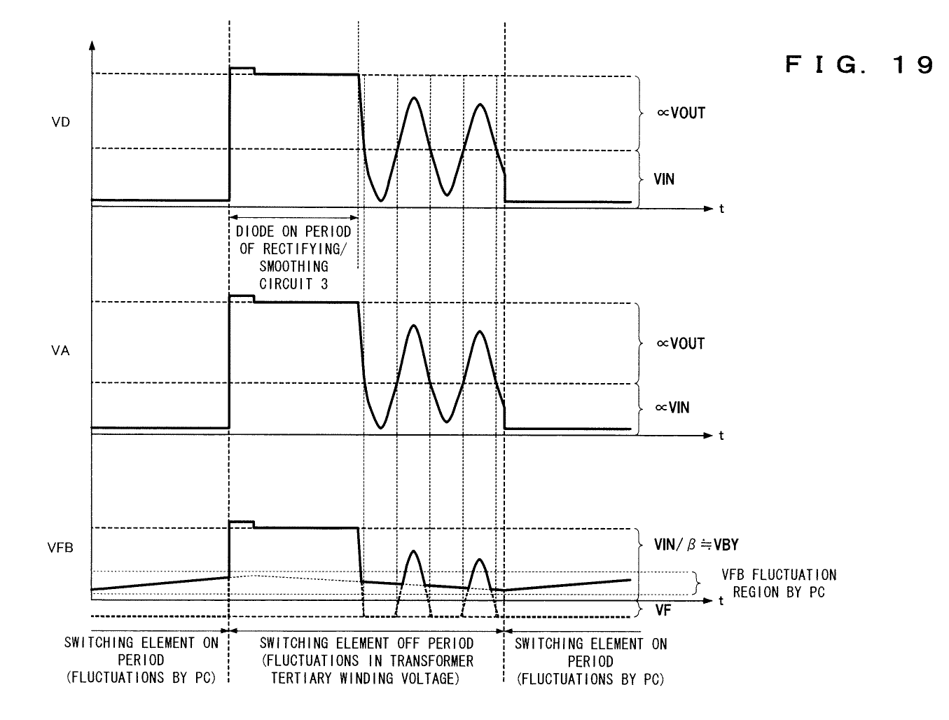

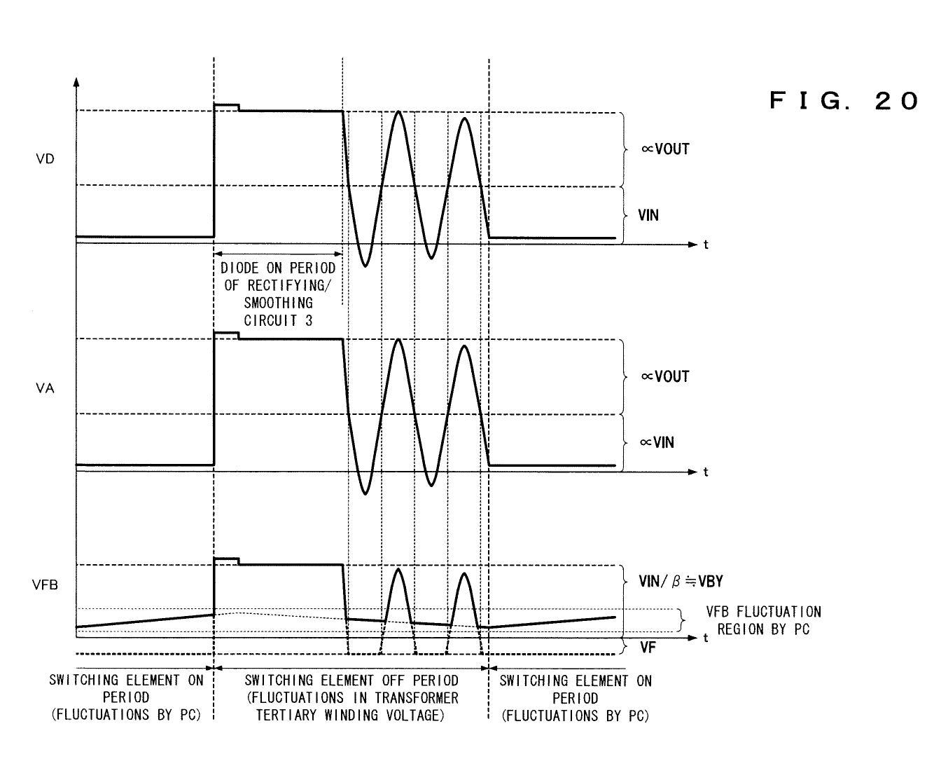

FIG. 18 shows the switching controller of the fourth embodiment. FIG. 19 shows waveforms at each point of the switching controller according to the fourth embodiment. FIG. 20 shows waveforms at each point of the switching controller according to the fourth embodiment when a switching element 2 has a proper built-in diode tolerance.

The switching controller of the fourth embodiment in FIG. 18 is different from the switching controller of the first embodiment in FIG. 1 in that a diode 8 of a composite signal generating circuit 4 has a different connection polarity and a tertiary winding 1-3 of a transformer 1 forms a flyback connection. Thus an FB terminal voltage VFB is generated by the composite signal generating circuit 4 as shown in FIG. 19.

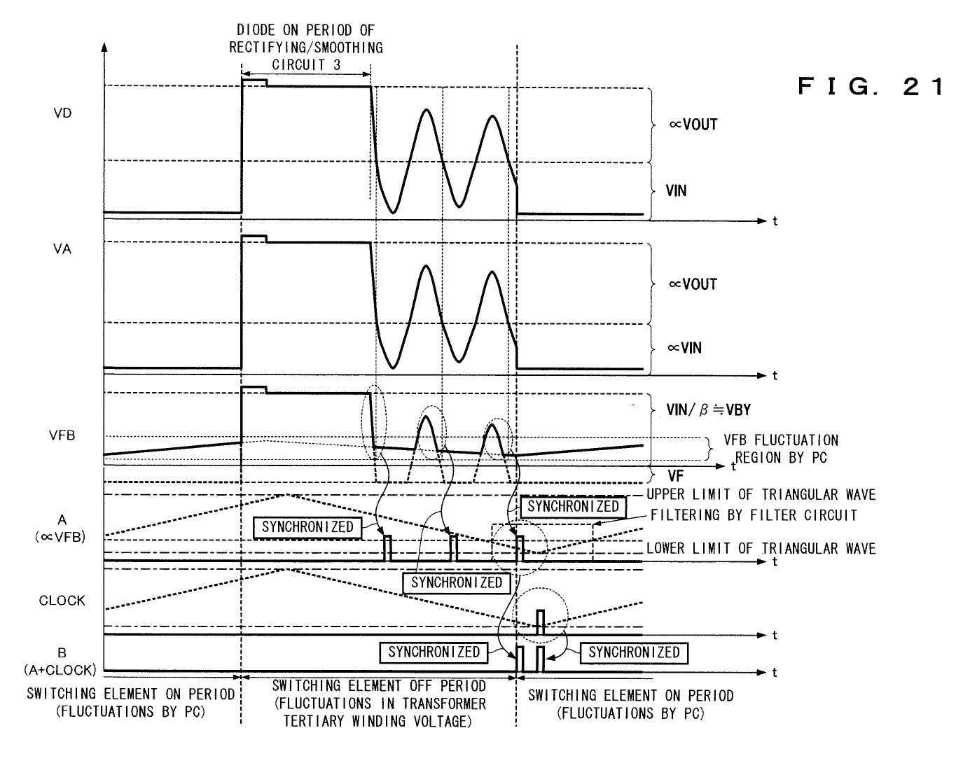

FIG. 21 shows voltage waveforms of each part when the first to fifth structural examples of the semiconductor device according to the embodiment are used in the switching controller of the fourth embodiment shown in FIG. 18. FIG. 21 is different from FIG. 5 in that a signal A outputted from the clock signal generating circuit 26 of the first to fifth structural examples of the semiconductor device according to the embodiment is generated at the falling edge of the FB terminal voltage VFB in the off period of the switching element 2. The same operation and effect of the switching controller can be obtained and thus the explanations of the other signals are omitted.

### Fifth Embodiment

The following will describe a switching controller and a semiconductor device used in the same according to a fifth embodiment of the present invention.

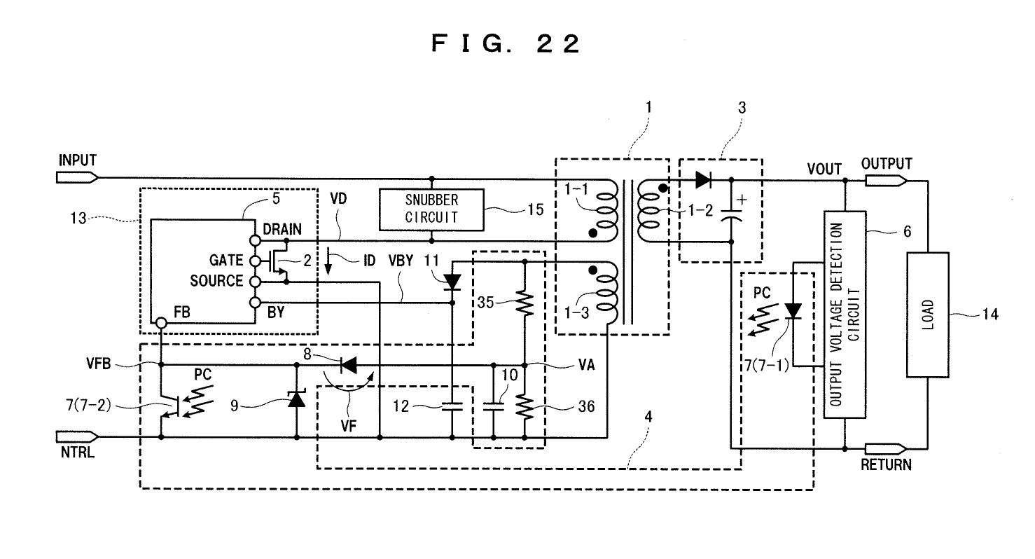

FIG. 22 shows the switching controller of the fifth embodiment. The fifth embodiment is different in that two resistors 35 and 36 are added in the composite signal generating circuit 4 of the switching controller of the fourth embodiment shown in FIG. 18. The same effect can be obtained by the addition of the two resistors 35 and 36 as the switching controller of the second embodiment shown in FIG. 14 and thus the explanation thereof is omitted.

### Sixth Embodiment

The following will describe a switching controller and a semiconductor device used in the same according to a sixth embodiment of the present invention.

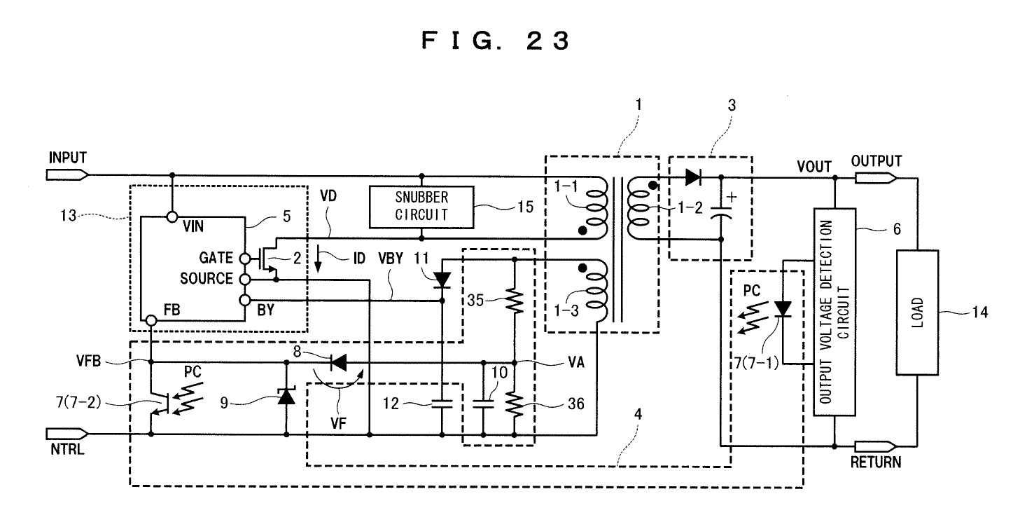

FIG. 23 shows the switching controller of the sixth embodiment. The sixth embodiment is different in that power is supplied to a control circuit 5 not from a DRAIN terminal of a switching element 2 but from a VIN terminal connected to an input terminal INPUT. The same effect is obtained and power is supplied from the VIN terminal to the control circuit 5 as in the switching controller of the third embodiment shown in FIG. 15. Thus the explanation of the effect and power supply is omitted.

What is claimed is:

1. A switching controller, comprising:
a switching element for turning on/off a DC voltage;
a composite signal generating circuit for generating a composite signal from a plurality of different input signals; and
a control circuit for controlling an on/off operation of the switching element in response to the composite signal from the composite signal generating circuit.

2. A switching controller, comprising:
an input terminal fed with a DC voltage;
a transformer comprising a primary winding having one end connected to the input terminal and an other end connected to a high-potential side terminal of a switching element, a secondary winding connected to an output voltage detection circuit via a rectifying/smoothing circuit, and a tertiary winding connected to a composite signal generating circuit connected to an output terminal of the output voltage detection circuit to generate a composite signal; and
a control circuit for controlling an on/off operation of the switching element on the DC voltage in response to the composite signal from the composite signal generating circuit.

3. The switching controller according to claim 2, wherein the composite signal generating circuit generates the composite signal from a plurality of different input signals by using an on period and an off period of the switching element such that the signals do not interfere with each other, and
the control circuit processes the composite signal from the composite signal generating circuit in the on period and the off period of the switching element, and controls the on/off operation of the switching element based on a processing signal.

4. The switching controller according to claim 3, wherein the composite signal generating circuit comprises at least a diode.

5. The switching controller according to claim 3, wherein the composite signal generating circuit comprises at least a diode and a Schottky diode.

6. The switching controller according to claim 3, wherein the composite signal generating circuit comprises at least a diode, a Schottky diode, and a photocoupler.

7. The switching controller according to claim 2, wherein the control circuit controls the on/off operation of the switching element based on the composite signal from the composite signal generating circuit such that a current passing through the switching element is adjusted in response to an output signal from the output voltage detection circuit in an on period of the switching element and timing of turn-on of the switching element is adjusted in response to an output signal from the tertiary winding of the transformer in an off period of the switching element.

8. The switching controller according to claim 2, wherein the control circuit controls the on/off operation of the switching element based on the composite signal from the composite signal generating circuit such that a current passing through the switching element is adjusted in response to an output signal from the output voltage detection circuit in an on period of the switching element and timing of turn-on of the switching element is adjusted in response to a reference signal from an oscillator for generating timing of switching and an output signal from the tertiary winding of the transformer in an off period of the switching element.

9. The switching controller according to claim 2, wherein the control circuit comprises:
an overcurrent detection circuit for detecting a current passing through the switching element and setting a maximum value of the detected current; and
an overload detection circuit for detecting an overload condition of the output terminal according to the number of times that the current passing through the switching element reaches the maximum value of the detected current of the overcurrent detection circuit.

10. The switching controller according to claim 2, wherein the control circuit comprises an adjusting circuit for detecting one of an unloaded condition and a light-load condition of the output terminal based on the composite signal from the composite signal generating circuit in an on period of the switching element and adjusting an oscillation condition of the switching element.

11. The switching controller according to claim 10, wherein the adjusting circuit changes an oscillation frequency of the switching element.

12. The switching controller according to claim 10, wherein the adjusting circuit stops or suspends on/off control of the switching element.

13. The switching controller according to claim 8, wherein the oscillator uses, as the reference signal, a triangular wave changing according to the composite signal from the composite signal generating circuit in the on period of the switching element.

14. A semiconductor device wherein, in the switching controller according to claim 2, the switching element and the control circuit are formed as an integrated circuit on the same semiconductor substrate or mounted in the same package and at least four terminals are provided.
